(19) United States
(12) Patent Application Publication
(10) Pub. No.: US 2003/0075617 A1
(43) Pub. Date: Apr. 24, 2003

(54) Rotary atomizer having a locking shaft

(76) Inventors: Michael Baumann, Flein (DE); Harry Krumma, Bonnigheim (DE)

Correspondence Address: HOWARD & HOWARD ATTORNEYS, P.C., THE PINEHURST OFFICE CENTER, SUITE #101, 39400 WOODWARD AVENUE, BLOOMFIELD HILLS, MI, 48304-5151, US

(21) Appl. No.: 10/256,428

(22) Filed: Sep. 27, 2002

Related U.S. Application Data
(60) Provisional application No. 60/367,692, filed on Mar. 26, 2002.

(30) Foreign Application Priority Data
Mar. 29, 2001 (DE) AN0104 15412 DE

(51) Int. Cl. B05B 3/00

(52) U.S. Cl. 239/225.1

(57) ABSTRACT

A rotary atomizer assembly includes a locking element (14) having a head end (17) and a blocking end (24), and a bearing unit (1) rotatably supporting a rotatable shaft (4) having a distal end (8) and an internal end presenting a locking hole (12). The distal end (8) has threads (9) for receiving a rotary atomizer. The shaft (4) includes a hole defining the locking hole (12) to receive the locking element (14) for preventing rotation of the shaft (4). The locking element (14) is supported by the bearing unit (1) for radial movement into and out of engagement with the shaft (4) and extends radially outwardly from the bearing unit (1). A restoring spring (20) is disposed on the locking element (14) and biases the locking element (14) radially out of the engagement with the shaft (4).

### CROSS-REFERENCE TO RELATED APPLICATIONS

This application claims the benefit of U.S. Provisional Patent Application Serial No. 60/367,692, filed Mar. 26, 2002 claiming the benefit of German Patent Application No. AN0104 15412 DE, filed Mar. 29, 2001.

### FIELD OF THE INVENTION

The present invention relates generally to rotary atomizers and, more particularly, to a rotary atomizer for a coating device.

### BACKGROUND OF THE INVENTION

Currently, paints are applied by rotary atomizers to work pieces, such as automobile bodies. Such rotary atomizers include an outer housing having a cover and a turbine driven by a motor, a spray cap including a bell disk and a bearing unit, and a hollow shaft. Typically, the hollow shaft is disposed on the spray cap. Within the outer housing cover, the bearing unit is mated with the turbine and forms a turbine assembly. Once the cover is removed, the assembly, along with the hollow shaft and the disk, are separable from the atomizer and removable, thereby allowing access to the assembly.

However, from time to time, the disk must be removed from the hollow shaft and cleaned or exchanged. In order to perform the necessary maintenance of the conventional atomizer, the disk must removed from the hollow shaft via a tool, such as a wrench, thereby requiring increased time, cost and effort. In addition, assembling and disassembling the atomizer through the use of tools increases the likelihood of damaging the atomizer and its components. Moreover, conventional atomizers require that additional parts be disassembled therefrom in order to access the shaft, thereby introducing contaminants and requiring additional cleaning.

### SUMMARY OF THE INVENTION AND ADVANTAGES

A rotary atomizer assembly for a coating device includes a bearing unit and a rotatable shaft rotatably supported in the bearing unit. The shaft includes a distal end extending from the bearing unit and having threads for receiving a rotary atomizer, and an internal end presenting a locking hole. The assembly includes a locking element having a blocking end and a head end. The locking element is moveably mounted on the bearing unit for movement between a first position engaging the locking hole for preventing rotation of the shaft in the bearing unit to unscrew the atomizer from the shaft and a second position disengaging the locking hole for allowing rotation of the shaft and the atomizer.

The rotary atomizer of the present invention reduces time, cost and effort required to disassemble and assemble the atomizer because the need for tools to perform maintenance and cleaning has been reduced or eliminated. Consequently, the likelihood of damaging the atomizer and its components during maintenance and cleaning is reduced. Moreover, it is not necessary to remove additional parts be in order to access the shaft, thereby reducing contaminants introduced into the assembly, thereby extending the time between cleanings.

### BRIEF DESCRIPTION OF THE DRAWINGS

Other advantages of the present invention will be readily appreciated as the same becomes better understood by reference to the following detailed description when considered in connection with the accompanying drawings wherein:

FIG. 1A is a cross-sectional view of a rotary atomizer having a locking element in a release position;

FIG. 1B is a cross-sectional fragmentary view of the rotary atomizer of FIG. 1 having the locking element in the locked position; and

FIG. 2 is a cross-sectional top view taken along line 1-1 of FIG. 1.

### DETAILED DESCRIPTION OF THE PREFERRED EMBODIMENT

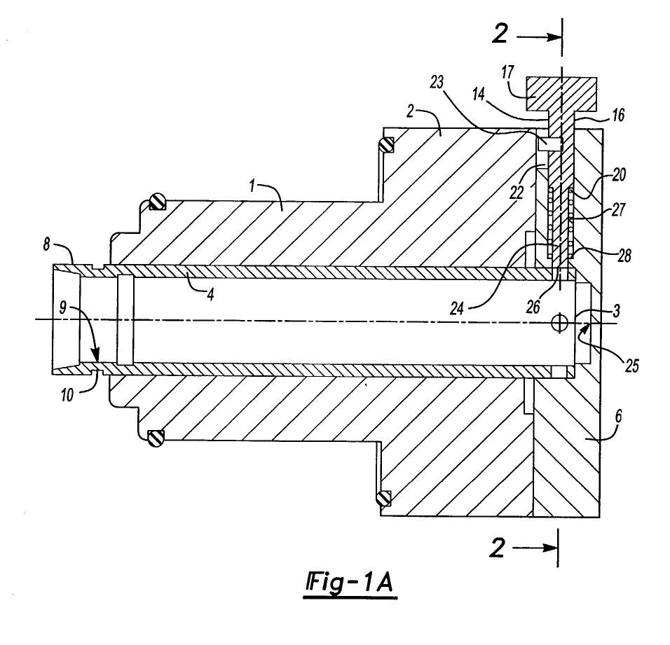

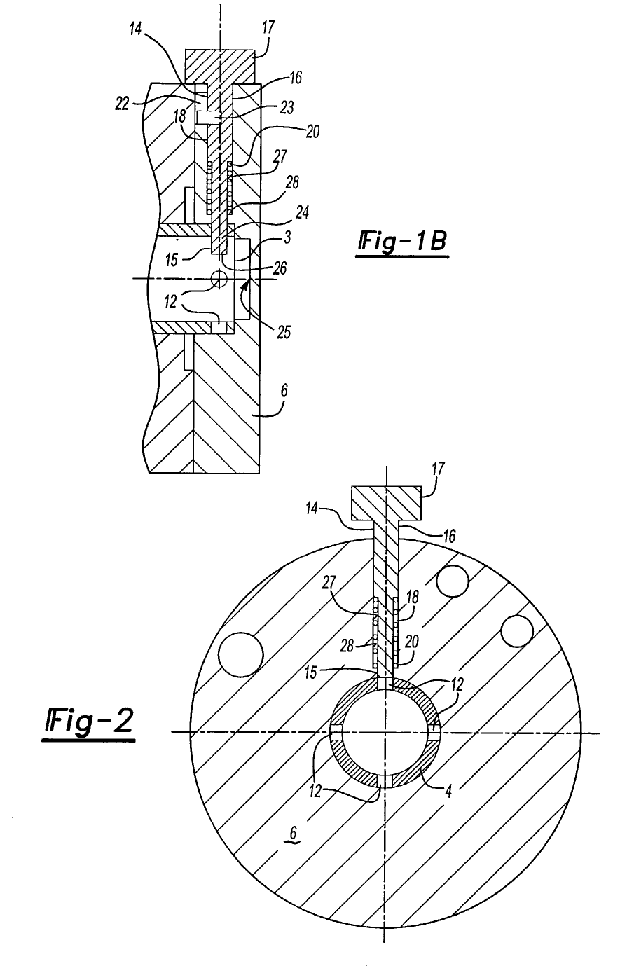

Referring to the Figures, wherein like numerals indicate like or corresponding parts throughout the several views, a rotary atomizer assembly for coating a device is shown in FIGS. 1A, 1B and 2.

The rotary atomizer assembly includes a bearing unit 1, a rotatable shaft 4 and a locking element 14 having a head end 17 and a blocking end 24 with a beveled edge 26. The rotatable shaft 4 is rotatably supported in the bearing unit 1 and includes a distal end 8 and an internal end 3. The distal end 8 extends from the bearing unit 1 and has threads 9 for receiving a rotary atomizer. The internal end 3 presents a locking hole 12. The rotatable shaft 4 includes at least one hole defining the locking hole 12 for receiving the blocking end 24 of the locking element 14 and preventing rotation of the shaft 4. As shown in FIG. 2, the internal end 3 defines four locking holes 12. The shaft 4 includes a site 10 where a tool may be applied for providing an additional means of securing the shaft 4 when desired.

The locking element 14 is supported by the bearing unit 1 for radial movement into and out of engagement with the shaft 4. The locking element 14 extends radially outwardly from the bearing unit 1 and is moveably mounted on the bearing unit 4 for movement between a first position and a second position. In the first position, the locking element 14 engages the locking hole 12 to prevent rotation of the shaft 4 in the bearing unit 1, thereby permitting the atomizer to be unscrewed from the shaft 4. In the second position, the locking element 14 disengages the locking hole 12 for allowing rotation of the shaft 4 and the atomizer.

A restoring spring 20 is disposed on the locking element 14 for biasing the locking element 14 toward the second position radially out of the engagement with the shaft 4. The locking element 14 is forced from the second position into the first position, as shown in FIG. 1B, by pressing on the head 17 of the locking element 14 against the biasing force of the spring 20. The locking element 14 may be operated either manually or automatically.

The bearing unit 1 presents a radial passage 18 having a shoulder 27 adjacent the shaft 4 to define a guide diameter 28 opening to the shaft 4. The locking element 14 has a small diameter 15 at the blocking end 24 disposed in the guide diameter and a spring diameter extending from the small diameter 15 to an abutment at a large diameter 16. The spring 20 is disposed about the spring diameter to react between the shoulder and the abutment.

The bearing unit I includes a cover plate 6, and the locking element 14 is supported by the cover plate 6. The cover plate 6 defines a gap 22 therein. A retaining pin 23 is slidably supported by the cover plate 6. The pin 23 is disposed in the gap 22 and engages the locking element 14 for retaining the locking element 14 in the cover 6. The cover plate 6 has a face, generally indicated at 25, engaging the remainder of the bearing unit 1, and the retaining pin 23 extends to the face.

The invention has been described in an illustrative manner, and it is to be understood that the terminology that has been used is intended to be in the nature of words of description rather than limitation. It will be apparent to those skilled in the art that many modifications and variations of the present invention are possible in light of the above teachings. Therefore, it is to be understood that the invention may be practiced otherwise than as specifically described within the scope of the amended claims.

What is claimed is:

1. A rotary atomizer assembly for a coating device comprising:
a bearing unit (1);
a rotatable shaft (4) rotatably supported in said bearing unit (1) and including a distal end extending from said bearing unit (1) and having threads (9) for receiving a rotary atomizer, and an internal end (3) presenting a locking hole (12);
a locking element (14) having a blocking end (24) and a head end (17) and slideably engageable with said bearing unit (4) for movement between a first position engaging said locking hole (12) for preventing rotation of said shaft (4) in said bearing unit (1) to unscrew said atomizer from said shaft (4) and a second position disengaging said locking hole (12) for allowing rotation of said shaft (4) and said atomizer.

2. An assembly set forth in claim 1 wherein said locking element (14) is supported by said bearing unit (1) for radial movement into and out of engagement with said shaft (4).

3. An assembly as set forth in claim 2 wherein said rotatable shaft (4) includes at least one hole defining said locking hole (12) to receive said blocking end of said locking element (14) for preventing rotation of said shaft (4).

4. An assembly as set forth in claim 3 including a restoring spring (20) disposed on the locking element (14) for biasing said locking element (14) toward said second position radially out of said engagement with said shaft (4).

5. An assembly as set forth in claim 4 wherein said locking element (14) extends radially outwardly from said bearing unit (1).

6. An assembly as set forth in claim 5 wherein said bearing unit (1) presents a radial passage (18) having a shoulder (27) adjacent said shaft (4) to define a guide diameter opening (28) to said shaft (4), said locking element (14) having a small diameter (15) at said blocking end disposed in said guide diameter (28) and a spring diameter extending from said small diameter (15) to an abutment at a large diameter (16), said spring (20) being disposed about said spring diameter to react between said shoulder (27) and said abutment.

7. An assembly as set forth in claim 5 wherein said blocking end (24) includes a beveled edge (26).

8. An assembly as set forth in claim 7 wherein said locking element (14) is operated manually.

9. An assembly as set forth in claim 7 wherein said bearing unit (1) includes a cover plate (6) and said locking element (14) is supported by said cover plate (6).

10. An assembly as set forth in claim 9 including a retaining pin (23) slidably supported by said cover plate (6) and engaging said locking element (14) for retaining said locking element (14) in said cover.

11. An assembly as set forth in claim 10 wherein said cover plate (6) includes a face (25) engaging the remainder of said bearing unit (1) and said retaining pin (23) extends to said face (25).
